(19) United States
(12) Patent Application Publication
(10) Pub. No.: US 2005/0083476 A1
(43) Pub. Date: Apr. 21, 2005

(54) Method for manufacturing a liquid crystal display panel

(76) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/966,538

(22) Filed: Oct. 15, 2004

(30) Foreign Application Priority Data
Oct. 15, 2003 (TW) 92128501

(51) Int. Cl. G02F 1/1339

(52) U.S. Cl. 349/153

(57) ABSTRACT

A method for manufacturing an LCD panel includes the steps of: applying a sealing member on a first substrate to define a display area substantially enclosed by the sealing member, the sealing member containing a plurality of spacers mixed therein; applying at least one drop of a liquid crystal material to the display area of the first substrate; assembling the first substrate and a second substrate in a vacuum chamber; and curing the sealing member to integrate the substrates and thereby form the LCD panel. In this method, there is no need to spray spacers into the display area of the LCD panel. Therefore the process is simplified. The cell gap of the LCD panel is completely determined by the quantity of the liquid crystal material. The LCD panel has a uniform cell gap so as to ensure that the LCD panel provides high optical performance.

### BACKGROUND OF THE INVENTION

1. Field of the invention

The present invention relates to methods for manufacturing liquid crystal display (LCD) panels, and more particularly to a method for manufacturing an LCD panel which omits a step of spraying spacers into a display area of the LCD panel.

2. Description of the Prior Art

An LCD device mainly comprises an LCD panel, and a backlight system mounted under the LCD panel for supplying light beams thereto. In a typical LCD panel, spacers are provided between a pair of substrates in order to forming a predetermined gap between the substrates. The substrates include display electrodes and alignment films disposed on opposite inner surfaces thereof. The gap between the substrates is filled with liquid crystal material, which is enclosed by a sealant.

FIG. 4 is an exploded, isometric view of an LCD panel 1 manufactured by a conventional method. The LCD panel 1 comprises a first substrate 2, a second substrate 3, a sealant 5 integrating the first and second substrates 2 and 3, and a number of spacers 7. The conventional method for manufacturing the LCD panel 1 includes the following steps: providing and cleaning the substrates 2 and 3; coating the sealant 5 on a surface of the substrate 3, thereby defining a display area (not labeled); spraying spacers 7 into the display area; dropping liquid crystal material (not shown) into the display area; assembling the first and second substrates 2 and 3; and curing the sealant 5 to thereby form the LCD panel 1.

This method has the following problems stemming from the spacers 7. First, when the spacers 7 are sprayed, this requires high precision mechanisms and technique in order to ensure that the spacers 7 are evenly distributed. This makes the fabricating process unduly burdensome. Second, in general, the spacers 7 are larger than the predetermined cell gap. After the process of dropping the liquid crystal material and assembling the two substrates 2 and 3, the assembly is baked and then cooled. The liquid crystal material adjacent the spacers 7 contracts over a distance greater than that of the liquid crystal material elsewhere in the cell gap. Thus vacuum bubbles are liable to be created at the spacers 7. This phenomenon prevents the LCD panel 1 from obtaining a uniform cell gap and providing high optical performance.

Therefore, it is desired to provide a new method for manufacturing an LCD panel which can omit the step of spraying spacers and overcome the above-described disadvantages of conventional processes.

### SUMMARY OF THE INVENTION

An object of the present invention is to provide a relatively simple method for manufacturing an LCD panel which ensures that the LCD panel still provides high optical performance.

In order to achieve the above-described object, a method in accordance with the present invention includes the steps of: applying a sealing member on a first substrate to define a display area substantially enclosed by the sealing member, the sealing member containing a plurality of spacers mixed therein; applying at least one drop of a liquid crystal material to the display area of the first substrate; assembling the first substrate and a second substrate in a vacuum chamber; and curing the sealing member to integrate the substrates and thereby form an LCD panel. In this method, there is no need to spray spacers into the display area of the LCD panel. Therefore the process is simplified. The cell gap of the LCD panel is completely determined by the quantity of the liquid crystal material dropped into the cell gap. The LCD panel has a uniform cell gap so as to ensure that the LCD panel provides high optical performance.

Other objects, advantages, and novel features of the present invention will become more apparent from the following detailed description when taken in conjunction with the accompanying drawings.

### BRIEF DESCRIPTION OF THE DRAWINGS

FIG. 1 is a flow chart of an exemplary method for manufacturing an LCD panel in accordance with the present invention.

FIG. 2 is an exploded, isometric view of an LCD panel manufactured by the method of the present invention.

FIG. 3 is a cross-sectional view of the LCD panel manufactured by the method of the present invention.

FIG. 4 is an exploded, isometric view of an LCD panel manufactured by a conventional method.

### DETAILED DESCRIPTION OF THE PRESENT INVENTION

Reference now will be made to the drawings to describe the present invention in detail.

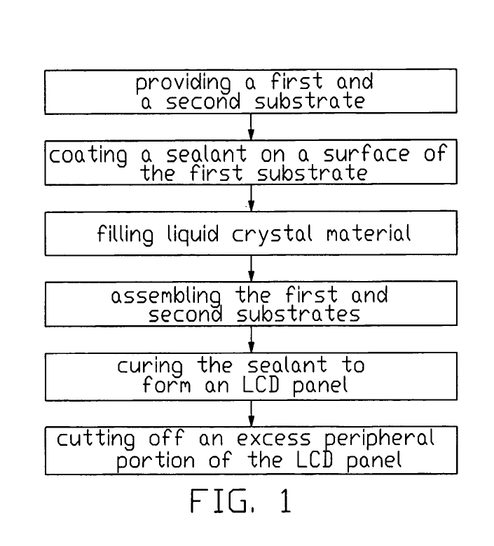

Referring to FIG. 1, a flow chart of an exemplary method for manufacturing an LCD panel in accordance with the present invention is shown. The steps involved in the manufacturing method are: providing a first substrate and a second substrate; coating a sealant on a surface of the first substrate; filling liquid crystal material into an area defined by the sealant; assembling the first and second substrates; curing the sealant to integrate the two substrates and the liquid crystal material together so as to form the LCD panel; and cutting off an excess peripheral portion of the LCD panel.

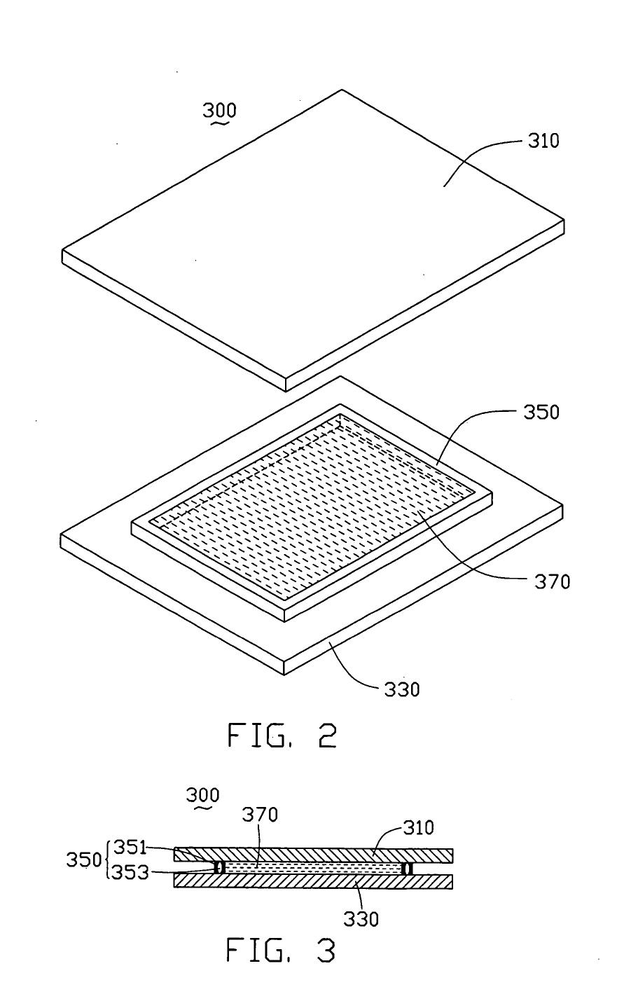

Referring also to FIG. 2, details of the above steps are as follows. A first TFT substrate 330 and a second color filter substrate 310 are provided. In the initial step, the substrates 310 and 330 are cleaned. After cleaning, liquid aligning material is applied to opposite surfaces of the substrates 310 and 330 by offset printing or a like process. Then a pre-bake and a full-bake process are performed. Thus, alignment films (not shown) are formed on the opposite surfaces of the substrates 310 and 330, respectively. Then, alignment treatment is performed on the alignment films by rubbing. In general, cleaning with water is performed after the rubbing, to wash off foreign matter and dirt.

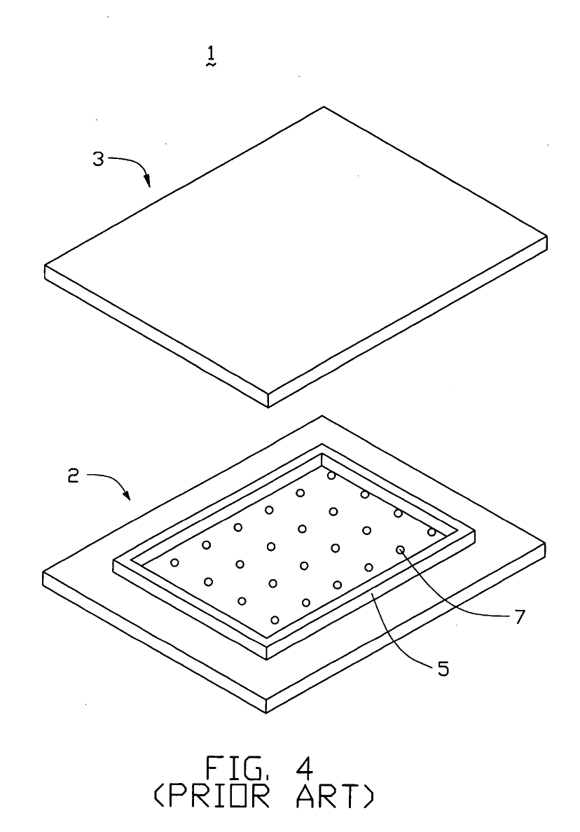

In the next step, a sealant 350 is coated on a surface of the first substrate 330 opposite to the second substrate 310, for enclosing liquid crystal material. The sealant 350 is coated by way of writing, screen printing, or a like process. The sealant 350 defines a display area (not labeled) on the surface of the first substrate 330. The sealant 350 may be made of a heat-curing type sealing material or an ultraviolet-curing type sealing material. Referring also to FIG. 3, in the exemplary embodiment, the sealant 350 is made of an ultraviolet-curing type sealing material 351, which contains a number of spacers 353 mixed therein. Each of the spacers 353 has an elliptical shape, and is made of glass fiber. A proportion of the spacers 353 in the sealant 350 is in the range from 0.5 wt % to 2 wt %, and preferably 1 wt %.

In the next step, liquid crystal material 370 is evenly dropped into the display area enclosed by the sealant 350 through a liquid crystal dispenser (not shown). The quantity of the liquid crystal material 370 dropped into the display area is determined by the predetermined cell gap of the LCD panel 300.

After dropping in the liquid crystal material 370, the first and second substrates 330 and 310 are accurately aligned, and then pressed in a vacuum chamber. The substrates 330 and 310 are thus pre-assembled.

In the next step, the sealant 350 is cured by irradiation with ultraviolet rays, so as to integrate the first and second substrates 330, 310 and thus form an LCD panel 300 (shown in FIG. 3).

In the final step, the excess peripheral portion of the LCD panel 300 is cut off. The process for fabricating the LCD panel 300 is thus completed.

Referring to FIG. 3, the LCD panel 300 includes the substrates 330, 310, and the liquid crystal material 370 sandwiched between the substrates 330, 310 and enclosed by the sealant 350. The sealant 350 is made of the ultraviolet-curing type sealing material 351 containing the spacers 353 mixed therein. The spacers 353 sustain edge portions of the two substrates 330 and 310 so as to form the cell gap therebetween. There are no spacers inside the LCD panel 300, and the cell gap is completely determined by the quantity of the liquid crystal material 370. The liquid crystal material 370 is resistant to compression. When the LCD panel 300 has a size less than 5 inches, the cell gap is stable, and there is no need for spacers inside the LCD panel 300.

Unlike with conventional processes, in the method of the present invention there is no need to spray spacers into the display area of the LCD panel 300. Thus the process is simplified. Moreover, because the LCD panel 300 has no spacers between the substrates 330 and 310 corresponding to the display area, material costs are reduced and an aperture ratio of the LCD panel 300 can be improved. The cell gap of the LCD panel 300 is completely determined by the quantity of the liquid crystal material 370 dropped into the cell gap. The LCD panel 300 has a uniform cell gap so as to ensure that the LCD panel 300 provides high optical performance.

It is to be understood, however, that even though numerous characteristics and advantages of the present invention have been set forth in the foregoing description, together with details of the function of the invention, the disclosure is illustrative only, and changes may be made in detail to the full extent indicated by the broad general meaning of the terms in which the appended claims are expressed.

1. A method for manufacturing a liquid crystal display panel, comprising the steps of:
applying a sealing member on a first substrate to define a display area substantially enclosed by the sealing member, the sealing member containing a plurality of spacers mixed therein;
applying a liquid crystal material to the display area of the first substrate;
assembling the first substrate and a second substrate in a vacuum chamber; and
curing the sealing member to integrate the substrates and thereby form the liquid crystal display panel.

2. The method for manufacturing a liquid crystal display panel as claimed in claim 1, further comprising the step of cutting off an excess peripheral portion of the liquid crystal display panel.

3. The method for manufacturing a liquid crystal display panel as claimed in claim 1, further comprising the step of cleaning the first and second substrates.

4. The method for manufacturing a liquid crystal display panel as claimed in claim 1, further comprising the step of forming alignment films on opposite surfaces of the first and second substrates.

5. The method for manufacturing a liquid crystal display panel as claimed in claim 1, wherein the sealing member is made of a heat-curing type sealing material.

6. The method for manufacturing a liquid crystal display panel as claimed in claim 1, wherein the sealing member is made of an ultraviolet-curing type sealing material.

7. The method for manufacturing a liquid crystal display panel as claimed in claim 1, wherein the spacers are made of glass fiber.

8. The method for manufacturing a liquid crystal display panel as claimed in claim 1, wherein a proportion of the spacers in the sealing member is in the range from 0.5 wt % to 2 wt %.

9. The method for manufacturing a liquid crystal display panel as claimed in claim 8, wherein the proportion of the spacers in the sealing member is 1 wt %.

10. A liquid crystal display panel comprising:
a pair of substrates spaced from each other in a vertical direction;
an elongated sealing member sandwiched between said pair of substrates around peripheral portions thereof, and cooperating with said pair of substrates to commonly define a closed space; and
liquid crystal material filled within said closed space; wherein
said elongated sealing member includes therealong a plurality of embedded spacers having superior strength to resist compression forces in the vertical direction in comparison with material of the sealing member.

11. The liquid crystal display panel as claimed in claim 10, wherein the closed space is only filled with the liquid crystal material without any spacers used for reinforcement of a structure of said panel.

12. The liquid crystal display panel as claimed in claim 10, wherein said spacers are evenly distributed along said sealing member.

13. A liquid crystal display panel comprising:
a pair of substrates spaced from each other in a vertical direction;
an elongated sealing member sandwiched between said pair of substrates around peripheral portions thereof, and cooperating with said pair of substrates to commonly define a closed space; and
liquid crystal material filled within said closed space; wherein
said elongated sealing member includes therealong a plurality of associated spacers and having superior strength to resist compression forces in the vertical direction in comparison with material of the sealing member.

14. The liquid crystal display panel as claimed in claim 13, wherein the closed space is only filled with the liquid crystal material without therein any spacers used for reinforcement of a structure of said panel.

15. The liquid crystal display panel as claimed in claim 13, wherein said spacers are evenly distributed along said sealing member.
